(19) United States
(12) Patent Application Publication
(10) Pub. No.: US 2006/0279705 A1
(43) Pub. Date: Dec. 14, 2006

(54) OPTICAL SYSTEM FOR OBLIQUE PROJECTION PROJECTOR

(75) Inventor: Minoru SUZUKI, Tokyo (JP)

Correspondence Address: GREENBLUM & BERNSTEIN, P.L.C., 1950 ROLAND CLARKE PLACE, RESTON, VA, 20191, US

(73) Assignee: PENTAX CORPORATION, Tokyo (JP)

(21) Appl. No.: 11/422,745

(22) Filed: Jun. 7, 2006

(30) Foreign Application Priority Data
Jun. 10, 2005 (JP) 2005/170605

(51) Int. Cl. G03B 21/00

(52) U.S. Cl. 353/31

(57) ABSTRACT

An optical system for a projector, through a projecting optical system on a screen, is provided. The optical system includes a modulating system configured to modulate color components corresponding to three primary colors in accordance with image data, the modulating system being configured such that the color components emerging from the modulating system proceed along optical paths different from those of color components incident on the modulating system, respectively, and a color combining system configured to combine the color components emerged from the modulating system, the combined color components being directed to the projecting optical system. The modulating system includes first through third reflecting optical elements. Each of the first through third reflecting optical elements is inclined with respect to a plane that includes axes of color components emitted from the first through third reflecting optical elements.

### BACKGROUND OF THE INVENTION

The present invention relates to a projector, and more specifically to a three-plate type projector that obliquely projects a color image on a screen using liquid crystal elements for respectively modulating color components to project the color image on the screen.

Liquid crystal color projectors are categorized into two types depending on how the type of the liquid crystal elements are used as modulating members: (1) a transmission type; and (2) a reflection type. The latter is configured to have relatively thin liquid crystal layers in comparison with the former, and has a quicker ON/OFF response, a longer life cycle and a higher light usage efficiency.

Further, the reflection type LC (liquid crystal) projectors are divided into two types: a three-plate type and a single plate type. Specifically, the three-plate type LC (liquid Crystal) projector employs three reflection type liquid crystal panels for modulating R (red), G (green) and B (blue) components, respectively. The single-plate type LC projector employs a single reflection type liquid crystal panel commonly used for modulating the R, G and B components. The tree-plate type projector is advantageous in comparison with the single-plate type projector in that the load in driving the liquid crystal element is reduced and images with higher brightness and higher quality can be projected. An example of such a three-plate type reflection projector is disclosed in Japanese Patent Provisional Publication No. P2002-98937A (hereinafter, referred to as '937 publication).

Recently, in order to further reduce the size of the projectors, one employing an oblique arrangement of the screen and modulating optical system with respect to the optical axis of the projecting optical system has been suggested. In the following description, such a projector will be referred to as an oblique projection projector. An example of such Annie oblique projection projector is disclosed in U.S. Pat. No. 5,032,022 (hereinafter, referred to as '022 publication). According to the oblique projecting projector disclosed in '022 publication, an optical distance between the projecting optical system and the screen can be sufficient long, and the projecting optical system can be arranged closer to the screen. Therefore, the projector can be made relatively thinner and smaller.

It is desirable that the oblique projecting projector employs the three-plate system. However, the configuration disclosed in '937 publication requires that the modulating optical system and the screen are arranged perpendicularly with respect to the optical axis of the projecting optical system. Thus, the configuration disclosed in '937 publication cannot apply to the configuration disclosed in '022 publication as it is.

Further, the projector disclosed in '937 publication employs a plurality of reflection surfaces for separating color components, and a color combining prism and at least one polarizing beam splitter (PBS). That is, the number of elements of the projector disclosed in '937 publication are relatively large, which increases the size and weight of the projector. Further, the PBS's are arranged in front of the reflection type liquid crystal panels for the color components, respectively, and part of optical paths of incident light and those of emerging light overlap and/or inner reflection occur, which results in flare or ghosting light and/or undesirable loss of light.

### SUMMARY OF THE INVENTION

In consideration of the foregoing problems of conventional arts, the present invention is advantageous in that an improved three-plate type oblique projecting projector can be provided. The improved projector is compact in size and can project bright and high-quality images.

According to an aspect of the invention, there is provided an optical system for a projector configured to project an image, through a projecting optical system, on a screen which is inclined such that a normal to the screen is inclined with respect to an optical axis of the projecting optical system, including a modulating system configured to modulate color components corresponding to three primary colors in accordance with image data, the modulating system being configured such that the color components emerging from the modulating system proceed along optical paths different from those of color components incident on the modulating system, respectively, and a color combining system configured to combine the color components emerged from the modulating system, the combined color components being directed to the projecting optical system. The modulating system includes first through third reflecting optical elements to which the primary color components are incident respectively. Each of the first through third reflecting optical elements is inclined with respect to a plane that includes axes of color components emitted from the first through third reflecting optical elements.

Optionally, the modulating system may be configured such that only light components contributing to formation of an image are directed to the color combining system.

Optionally, the optical system may receive white light from a light source. The optical system may further include a color dividing system configured to divide the white light into the color components which are directed to the modulating system.

Optionally, the color dividing system may be arranged in alignment with the color modulating system and the color combining system in a direction approximately perpendicular to the plane that includes the axes of the color components emitted from the first through third reflecting optical elements.

Optionally, the color dividing system may include a first color dividing optical element that divides the white light into a first color component and a remaining component, the first color component being directed to the modulating system, a second color dividing optical element that divides the remaining color component into a second color component and a third color component, a first deflecting optical element configured to direct the second color component to the modulating system, and a third deflecting optical element configured to direct the third color component to the modulating system.

Optionally, the first deflecting optical element may deflect the second color component substantially perpendicularly. The second deflecting optical element may deflect the third color component substantially perpendicularly.

Optionally, when the light source emits light in a first linearly-polarized state, the modulating system may modulate each of the color components emerged from the modulating system such that each color component is in a second linearly-polarized state which is rotated from the first linearly-polarized state by 90 degrees in accordance with the image data.

Optionally, the color combining system may selectively combine the color components modulated by the modulating system in accordance with the polarization state of each of the color components.

Optionally, the color combining system may include a first combining surface that reflects the first through third color components in the first linearly-polarized state and the first color component in the second linearly-polarized state, and a second combining surface that forms a right angle with respect to the first combining surface and reflects the first through third color components in the first linearly-polarized state and the second color components in the second linearly-polarized state.

Optionally, the color components transmitted through the first combining surface and the second combining surface may be combined and directed to the projecting optical system.

Optionally, the first linearly-polarized state may be an S polarized state and the second linearly-polarized state is a P polarized state.

Optionally, each of the first through third reflecting optical elements may include a reflection type liquid crystal element which is driven in accordance with image data.

Optionally, each of the first through third reflecting optical elements may reflect the incident color component perpendicularly.

### BRIEF DESCRIPTION OF THE ACCOMPANYING DRAWINGS

FIG. 1 schematically shows a configuration of an optical system of a projector according to an embodiment of the invention.

FIG. 2 is a cross-sectional view of the optical system taken along line α-α of FIG. 1.

FIG. 3 is a cross-sectional view of the optical system taken along line β-β of FIG. 1.

FIG. 4 is an enlarged view of color combining element according to the embodiment of the invention.

FIG. 5A shows a relationship between a wavelength of incident light and a transmission factor of a first color combining surface of the color combining elements.

FIG. 5B shows a relationship between a wavelength of incident light and a transmission factor of a second color combining surface of the color combining elements.

### DETAILED DESCRIPTION OF THE EMBODIMENTS

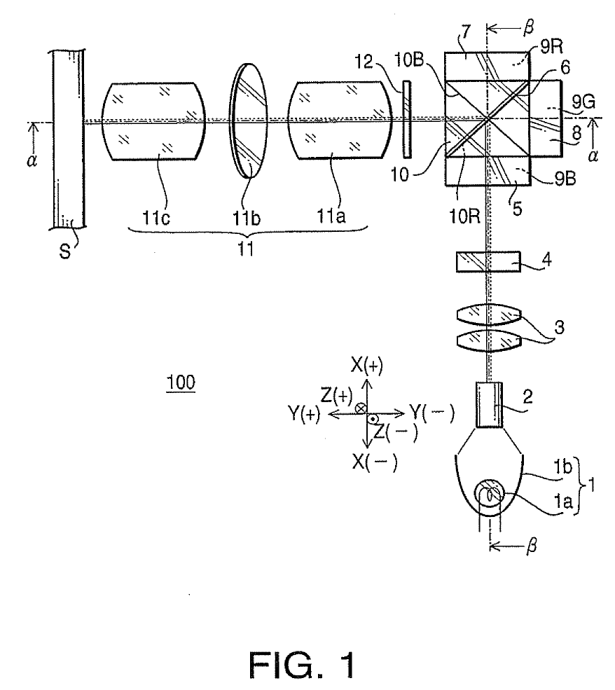

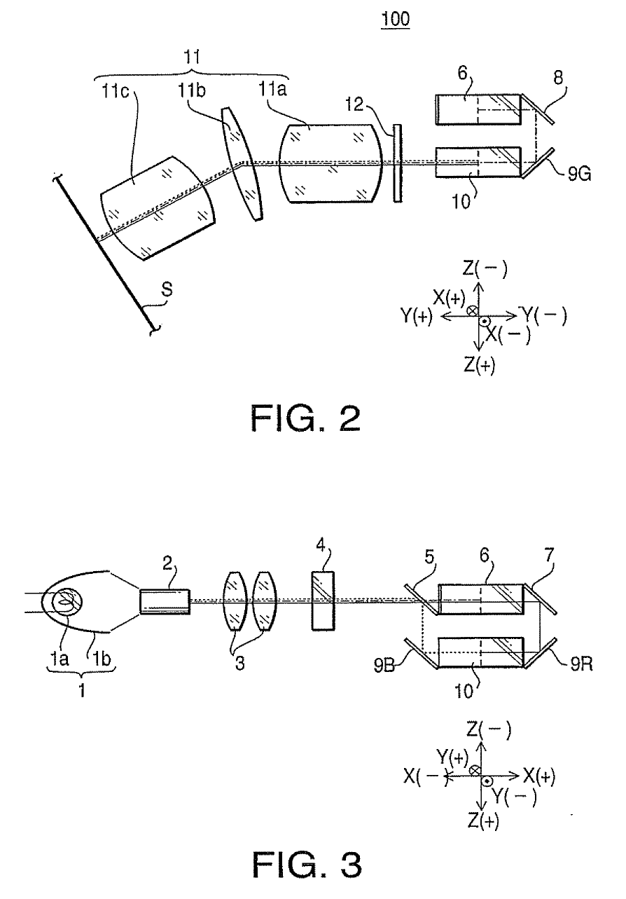

FIG. 1 is a top view of an optical system 100 for a projector according to a first embodiment of the invention. The optical system 100 is employed in the three-plate type oblique projecting projector. FIG. 2 is a cross-sectional view of the optical system 100 taken along line α-α of FIG. 1, and FIG. 3 is a cross-sectional view of the optical system 100 taken along line β-β of FIG. 1.

As shown in FIG. 1, the optical system 100 includes, a light source 1, a light tunnel® 2, a relay lens group 3, a single polarizing plate 4, a first dichroic mirror 5, a second dichroic mirror 6, a first mirror 7, a second mirror 8, a reflection type liquid crystal element 9R for the red component, a reflection type liquid crystal element 9G for the G component, a reflection type liquid crystal element 9B for the B component, a color combining element 10, a projection lens group 11, and an absorbing polarizing plate 12.

The light source 1 includes a high-pressure Hg lamp 1a and an oval reflector 1b. The first dichroic mirror 5 is configured to have a wavelength characteristic of deflecting a B (blue) light component. The second dichroic mirror 6 is configured to have a wavelength characteristic of deflecting the G component. The projection lens group 11 includes a first lens group 11a, a deflection optical element 11b, and a second lens group 11c.

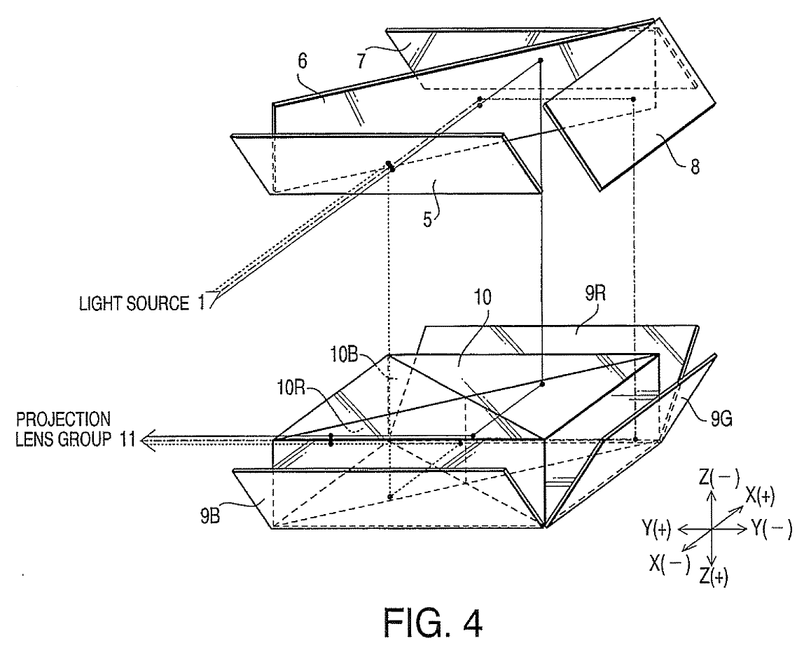

FIG. 4 is an enlarged view of components around the color combining element 10. In FIG. 4, for the purpose of explanation, a distance between the first dichroic mirror 5, second dichroic mirror 6, first mirror 7, second mirror 8 and the reflection elements 9R, 9G, 9B and the color combining element 10 is exaggerated.

The color combining element 10 is formed by cementing four right-angle prisms and is cube-shaped. As shown in FIG. 4, the color combining element 10 has first color combining surfaces 10B and second color combining surfaces 10R, which are cemented surfaces of the four prisms. The first color combining surfaces 10B are perpendicular to the second color combining surfaces 10R.

As shown in FIGS. 2-4, the projector optical system 100 is configured such that a group of mirrors 5-8 are arranged above the reflection type liquid crystal elements 9R, 9G and 9B and the color combining element 10. Each of the mirrors 5-8 are inclined with respect to the oblique surfaces of the rectangular prisms constituting the color combining element 11 by a predetermined angle when the mirrors 5-8 are correctly positioned above the liquid crystal elements 9R, 9G and 9B and the color combining element 10. Further, the liquid crystal elements 9R, 9G and 9B are inclined with respect to a plane that includes axes of the color components emitted from the liquid crystal elements 9R, 9G, and 9B. More specifically, reflection surfaces of the liquid crystal elements 9R, 9G and 9B are inclined with respect to the oblique surfaces of the rectangular prisms constituting the color combining element 10 by a predetermined angle. With the above configuration, it is possible to reduce the size (in Z-axis direction in the drawings) of the color combining element 10. Therefore, even though the two groups of optical systems are arranged in Z-axis direction, the entire size of the optical system, the projector can be decreased even in comparison with an optical system employing a conventional structure.

White light emitted by the high-pressure Hg lamp 1a is reflected by the oval reflector 1b and is directed to the light tunnel 2. The light tunnel 2 directs the incident white light to the relaying lens group 3 with maintaining the intensity distribution of the white light. The relaying lens group 3 converts the white light emerged from the light tunnel 2 to parallel light and directs the same to the single polarization plate 4. The single polarization plate 4 directs the incident white light to the first dichroic mirror 5 as S-polarized light.

The S-polarized light from the first polarization plate 4 is incident on the first dichroic mirror 5. Then, the first dichroic mirror 5 deflects the B component from among color components of the incident white light, and allows the other (i.e., R and G) components to pass therethrough, without deflecting the same. It should be noted that the first dichroic mirror 5 is arranged such that the B component is deflected perpendicularly (i.e., the incident ray and deflected ray form right angles). Incidentally, in the drawings, the optical path of an R component is represented by a solid line, the optical path of a B component ray is represented by a dotted line, and the optical path of a G component ray is represented by a broken line.

Directions X, Y and Z indicated in each drawings are defined as follows. X(+) direction represents a direction of light emitted by the light source 1 and passed through the light tunnel 2, and X(−) direction represents a direction opposite to the X(+) direction. Y(+) direction represents a direction perpendicular to the X direction (X(+) and X(−) directions) and a direction from the color combining element 10 to the fist lens group 11a, and Y(−) direction is a direction opposite to the Y(+) direction. Z(+) direction represents a direction perpendicular to both the X direction and Y direction, and a direction in which the light deflected by the first dichroic mirror 5 proceeds. Z(−) direction represents the direction opposite to the Z(+) direction.

The G and R components passed through the first dichroic mirror 5 proceed in the X(+) direction and are incident on the second dichroic mirror 6. The second dichroic mirror 6 is configured to allow the R component without deflection, while deflects the G component. In this embodiment, the second dichroic mirror 6 is arranged such that the G component is deflected perpendicularly to proceed in the Y(−) direction.

The B component substantially perpendicularly deflected by the first dichroic mirror 5 and proceeding in the Z(+) direction is incident on the reflection type liquid crystal element 9B for the B component. The liquid crystal element 9B is arranged such that the reflection surface thereof is parallel with the first dichroic mirror 5 and the liquid crystal surface faces the reflection surface of the mirror 5.

The reflection type liquid crystal element 9B modulates the B component light. Specifically, the reflection type liquid crystal element 9B is driven in accordance with a modulating signal transmitted from a controller. It should be noted that the modulating signal is generated based on an image signal for the B component light.

The B component light incident on the ON bits are converted into P-polarized light due to the characteristic of the liquid crystal, while the B component light incident on the OFF bits remains as the S-polarized light. The B component light reflected by the reflection type liquid crystal element 9B is incident on the color combining element 10.

As described above, the reflection type liquid crystal element 9B is arranged such that the reflection surface is parallel with the first dichroic mirror 5. Thus, the B component light is reflected by the reflection type liquid crystal element 9B substantially perpendicularly to proceed in the X(+) direction.

The R component light passed through the second dichroic mirror 6 is reflected perpendicularly by the first mirror 7 which is arranged parallelly with the first dichroic mirror 5, and proceeds in the Z(+) direction. Then, the R component light is incident on the reflection type liquid crystal element 9R for the R component light. The reflection type liquid crystal element 9R is arranged perpendicularly with respect to the first mirror 7 (and thus, the first dichroic mirror 5), and the liquid crystal surface thereof faces the reflection surface of the first mirror 7.

The reflection type liquid crystal element 9R has the similar function to the above-described reflection type liquid crystal element 9B. The reflection type liquid crystal element 9R is driven in accordance with the image signal of the R component. The R component light incident on ON bits are converted into P-polarized light. The R component light is reflected by the reflection type liquid crystal element 9B perpendicularly, and proceeds in the X(−) direction.

The G component light reflected by the second dichroic mirror 6 is deflected substantially perpendicularly by the second mirror 8, and proceeds in the Z(+) direction. The G component is then incident on the reflection type liquid crystal element 9G. The reflection type liquid crystal element 9G is arranged such that the reflection surface thereof and the reflection surface of the second mirror 8 face with each other and form a right angle.

The reflection type liquid crystal element 9G is driven in accordance with the image signal of the G component. The G component light incident on ON bits of the reflection type crystal element 9G is converted into P-polarized light. The G component light is reflected by the reflection type liquid crystal element 9G perpendicularly, and proceeds in the Y(+) direction.

As described above, with respect to the color combining element 10, the liquid crystal element 9B is arranged on the X(−) direction, the liquid crystal element 9R is arranged on the X(+) direction, and the liquid crystal element 9G is arranged on the Y(−) direction. Further, the first dichroic mirror 5 is arranged on the Z(−) direction of the liquid crystal element 9B, and the second dichroic mirror 6 is arranged on the Z(−) direction of the color combining element 10. The first mirror 7 is arranged on the Z(−) direction of the liquid crystal element 9R, and the second mirror 8 is arranged on the Z(−) direction of the liquid crystal element 9G.

Each of the liquid crystal elements 9R, 9G and 9B is inclined with respect to the color combining element 10 so that the incident light is reflected perpendicularly. That is, the central lines of the light respectively reflected by the liquid crystal element 9R, 9G and 9B are on the same plane (which is an X-Y plane in this embodiment).

With the above-described structure, a thickness of the projector optical system 100 in the Z direction can be suppressed. In particular, the first dichroic mirror 5, the second dichroic mirror 6, the first mirror 7 and the second mirror 8 are arranged above (i.e., in the Z direction with respect to) the reflection type liquid crystal elements 9R, 9G and 9B and the color combining element 10. Such a structure contributes to downsizing of the optical system.

Optionally, the upper surface, which faces the mirrors 5-8, of the color combining element 10 may be coated with heat-resistant black coating. With such a configuration, unnecessary light inside the optical elements due to, for example, the off-axial light can be absorbed/blocked effectively, and ghosting light and/or flare can be effectively prevented.

Next, an image generating process using the color combining optical system will be described.

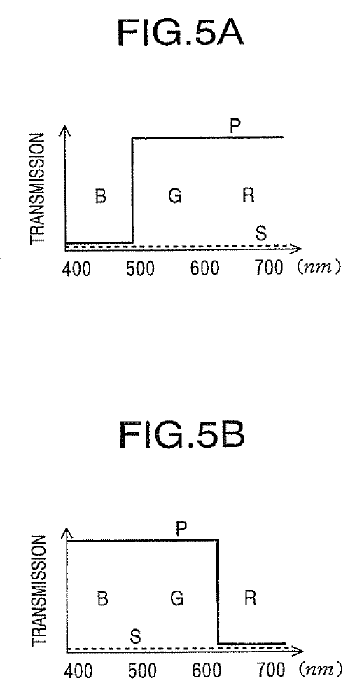

The color components respectively reflected by the reflection type liquid crystal elements 9R, 9G, and 9B are incident on the color combining element 10. FIG. 5A shows a graph schematically illustrating a relationship between the wavelength of the incident light and the transmission factor of the first color combining surface 10B. FIG. 5B shows a graph schematically illustrating a relationship between the wavelength of the incident light and the transmission factor of the second color combining surface 10R. In each graph, the horizontal axis represents the wavelength of the incident light, and the vertical axis represents the transmission factor. Further, the solid lines show a characteristic of the P-polarized light, while the broken lines show a characteristic of the S-polarized light.

As shown in FIG. 5A, the first color combining surface 10B has a high transmission factor for the G and R components in the P-polarized state, while has a low transmission factor for the P-polarized B component, and all S-polarized components. Further, as shown in FIG. 5B, the second color combining surface 10R has a high transmission factor for the B and G component in the P-polarized state. The second color combining surface 10R has a very low transmission factor with respect the R component in either of the S-polarized state or the P-polarized state.

As described above, due to the wavelength characteristics and the polarization characteristics of the two color combining surfaces 10B and 10R:

(a) the B-component light in the P-polarized state incident on the color combining element 10 is reflected by the first reflection surface 10B perpendicularly;

(b) the R-component light in the P-polarized state incident on the color combining element 10 is reflected by the second reflection surface 10R perpendicularly; and

(c) the G-component light in the P-polarized state incident on the color combining element 10 passes through both the reflection surfaces 10R and 10B.

With the above configuration, the P-polarized R, G and B components respectively modulated by the reflection type liquid crystal elements 9R, 9G and 9B are combined. The light combined and emerged from the color combining element 10 is incident on the projection lens group 11. The S-polarized R, G and B components are reflected by the color combining surfaces 10B and 10R, and are directed toward the light source 1 via the liquid crystal elements 9R, 9G and 9B. That is, the color combining surfaces 10B and 10R, and the reflection type liquid crystal elements 9R, 9G and 9B prevent unnecessary components light from directing toward the projection lens group 11. Thus, the ghosting light and/or flare can be effectively prevented, and bright images having a high quality can be formed.

According to the embodiment, in order to realize the higher quality of the image, a light absorbing polarization plate 12 for blocking the S-polarized component light, which is the unnecessary light, is inserted between the color combining element 10 and the projection lens group 11.

The light emerged from the color combining element 10 proceeds through the first lens group 11a and forms an intermediate image, which is inclined with respect to the optical axis, at a position adjacent to a deflection optical element 11b. The deflection optical element 11b is a lens having a deflecting function and is arranged such that the optical axis thereof is shifted and inclined with respect to the optical axis of the first lens group 11a. The deflecting optical element 11b directs the light emerged from the first lens group 11a to the second lens group 11c (see FIG. 2). It should be noted that the deflecting optical element need not be limited to a glass lens or plastic lens, but can be a Fresnel lens, a Fresnel mirror, an achromatic prism, and the lice.

Since each of the reflection type liquid crystal elements 9R, 9G and 9B is inclined with respect to the optical axis of the first lens group 11a, the intermediate image formed in the vicinity of the deflecting optical element 11b contains trapezoidal distortion due to variation of magnification depending on an image height.

The intermediate image containing the trapezoidal distortion and inclination with respect to the optical axis is deflected by the deflecting optical element 11b, and re-formed on the screen S via the second lens group 11c (see FIG. 2). It should be noted that the screen S is inclined with respect to the optical axis of the second lens group 11c such that the distortion of the intermediate image is cancelled. With this configuration, although the liquid crystal elements 9R, 9G and 9B are inclined, an image having no trapezoidal distortion is formed on the screen S. Further, the unnecessary light has been eliminated by the color combining element 10 and the liquid crystal elements 9R, 9G and 9B, a relatively large, bright and high-quality full color image can be projected on the screen S.

It should be noted that, in the embodiment, the mirrors 5-8 are arranged such that they are spaced from the liquid crystal elements 9R, 9G and 9B and the color combining element 10 in the Z direction. It is possible to modify the configuration such that, for example, the minors 5-8 are formed integrally with the color combining element 10.

The above-described projector optical system is an illustrative embodiment, and the invention need not be limited to the above-described configuration.

For example, between the color combining element 10 and each of the reflection type liquid crystal elements 9R, 9G and 9B, a polarization plate, a phase difference (retardation) plate and/or a compensation plate in accordance with the operation of the liquid crystal can be provided to improve the optical efficiency and/or to deal with flare and high temperature. By employing a prism between the color combining element 10 and each of the reflection type liquid crystal elements 9R, 9G and 9B, a back focus of the first lens group 11a can be shortened. It should be noted that, although not described, the above-described configuration can be modified in various ways employing various optical elements.

In the embodiment described above, the arrangement of the optical elements are determined to downsize the entire optical system and to ease the positioning of respective elements. It should be noted that, depending on purposes, the arrangement (e.g., the inclination amount of liquid crystal elements 9R, 9G and 9B) may be determined.

In the embodiment, in order to cancel the trapezoidal distortion of the image due to the inclined projection of the image, the reflection type liquid crystal elements 9R, 9G and 9B, the screen S and the image plane of the intermediate image are inclined with respect to the optical axis of the projection optical system. It should be noted that the invention need not be limited to the configuration of the illustrative embodiment. For example, the inclination of the liquid crystal elements 9R, 9G and 9B and the screen S is suppressed so that the trapezoidal distortion does not substantially affect the quality in observing the image, and the image is projected on the screen S with a single projection lens group.

Alternatively, in a structure using a single projection lens group and the inclined screen S, let the liquid crystal elements 9R, 9G and 9B be inclined, compensation can be made by modifying the image data and/or the shape of he B component.

Further, in the illustrative embodiment, the reflection type liquid crystal elements are employed. The invention need not be limited to this configuration and, although the entire configuration should be changed, transmission type liquid crystal elements 9R, 9G and 9B can be provided so that the trapezoidal distortion is cancelled as a result of distortions in opposite directions.

In the illustrative embodiment described above, the light emitted by the light source is converted into the S-polarized light using the polarization plate 4. This can be modified such that the light is converted in to the P-polarized light. Further, the optical paths of the color components described above can be changed arbitrarily. That is, the first dichroic mirror 5 may be configured to a color component other than B component. Further, transmission type liquid crystal elements can be used to configure a similar optical system. Such a modification can be readily made by a person skilled in the art.

The present disclosure relates to the subject matter contained in Japanese Patent Application No. 2005-170605, filed on Jun. 10, 2005, which is expressly incorporated herein by reference in its entirety.

What is claimed is:

1. An optical system for a projector configured to project an image, through a projecting optical system, on a screen which is inclined such that a normal to the screen is inclined with respect to an optical axis of the projecting optical system, comprising:
a modulating system configured to modulate color components corresponding to three primary colors in accordance with image data, the modulating system being configured such that the color components emerging from the modulating system proceed along optical paths different from those of color components incident on the modulating system, respectively; and
a color combining system configured to combine the color components emerged from the modulating system, the combined color components being directed to the projecting optical system,
wherein the modulating system includes first through third reflecting optical elements to which the primary color components are incident respectively, and
wherein each of the first through third reflecting optical elements is inclined with respect to a plane that includes axes of color components emitted from the first through third reflecting optical elements.

2. The optical system according to claim 1,
wherein the modulating system is configured such that only light components contributing to formation of an image are directed to the color combining system.

3. The optical system according to claim 1,
wherein the optical system receives white light from a light source, and
wherein the optical system further comprises a color dividing system configured to divide the white light into the color components which are directed to the modulating system.

4. The optical system according to claim 3,
wherein the color dividing system is arranged in alignment with the color modulating system and the color combining system in a direction approximately perpendicular to the plane that includes the axes of the color components emitted from the first through third reflecting optical elements.

5. The optical system according to claim 3,
wherein the color dividing system includes:
a first color dividing optical element that divides the white light into a first color component and a remaining component, the first color component being directed to the modulating system;
a second color dividing optical element that divides the remaining color component into a second color component and a third color component;
a first deflecting optical element configured to direct the second color component to the modulating system; and
a third deflecting optical element configured to direct the third color component to the modulating system.

6. The optical system according to claim 5,
wherein the first deflecting optical element deflects the second color component substantially perpendicularly, and
wherein the second deflecting optical element deflects the third color component substantially perpendicularly.

7. The optical system according to claim 1,
wherein, when the light source emits light in a first linearly-polarized state, the modulating system modulates each of the color components emerged from the modulating system such that each color component is in a second linearly-polarized state which is rotated from the first linearly-polarized state by 90 degrees in accordance with the image data.

8. The optical system according to claim 7,
wherein the color combining system selectively combines the color components modulated by the modulating system in accordance with the polarization state of each of the color components.

9. The optical system according to claim 8,
wherein the color combining system includes:
a first combining surface that reflects the first through third color components in the first linearly-polarized state and the first color component in the second linearly-polarized state; and
a second combining surface that forms a right angle with respect to the first combining surface and reflects the first through third color components in the first linearly-polarized state and the second color components in the second linearly-polarized state.

10. The optical system according to claim 9,
wherein the color components transmitted through the first combining surface and the second combining surface are combined and directed to the projecting optical system.

11. The optical system according to claim 7,
wherein the first linearly-polarized state is an S polarized state and the second linearly-polarized state is a P polarized state.

12. The optical system according to claim 1,
wherein each of the first through third reflecting optical elements includes a reflection type liquid crystal element which is driven in accordance with image data.

13. The optical system according to claim 1,
wherein each of the first through third reflecting optical elements reflects the incident color component perpendicularly.
